(19) United States
(12) Patent Application Publication
(10) Pub. No.: US 2026/0233911 A1
(43) Pub. Date: Aug. 13, 2026

(54) CARTON FOR CONTAINERS

(71) Applicant: Graphic Packaging International, LLC, Atlanta, GA (US)

(72) Inventor: Rinke Feenstra, Sneek (NL)

(21) Appl. No.: 19/533,748

(22) Filed: Feb. 9, 2026

Related U.S. Application Data
(60) Provisional application No. 63/757,469, filed on Feb. 12, 2025.

(51) Int. Cl. B65D 71/36; B31B 50/26

(52) U.S. Cl. CPC B65D 71/36; B31B 50/26; B65D 2571/00141; B65D 2571/00462; B65D 2571/00524; B65D 2571/00561; B65D 2571/0066; B65D 2571/00728

(57) ABSTRACT

A reinforced carton includes a carton and a reinforcement construct in at least partial face-to-face contact with a portion of the carton. The carton includes a plurality of panels extending at least partially around an interior of the carton, a plurality of end flaps in at least partially overlapping relation to form at least one closed end of the carton, and handle features at least partially forming a handle of the reinforced carton. The handle features include a reinforcement construct having a central panel, at least one handle panel, and at least one locking flap, a portion of the at least one handle panel positioned between the at least one locking flap and the central panel such that the at least one handle panel is moveable relative to the central panel from a first position to a second position upon activation of the handle.

### CROSS-REFERENCED TO RELATED APPLICATIONS

This application claims the benefit of U.S. Provisional Patent Application No. 63/757,469, filed on Feb. 12, 2025.

### INCORPORATION BY REFERENCE

The disclosure of U.S. Provisional Patent Application No. 63/757,469, which was filed on Feb. 12, 2025, is hereby incorporated by reference for all purposes as if presented herein in their entirety.

### BACKGROUND

The present disclosure generally relates to cartons for holding beverage containers or other types of articles. More specifically, the present disclosure relates to cartons configured with handle features that facilitate even stress distribution across portions of the carton when carried by a user.

### SUMMARY OF THE DISCLOSURE

According to one aspect, the disclosure is generally directed to a carton for containing a plurality of articles, the carton comprising a plurality of panels extending at least partially around an interior of the carton, the plurality of panels comprising a top panel, a bottom panel, a front panel, and a back panel, a plurality of end flaps foldably connected to a respective panel of the plurality of panels and in at least partially overlapping relation to form at least one closed end of the carton. Handle features at least partially forming a handle of the carton, the handle features comprise a reinforcement construct overlapping a portion of the carton, the reinforcement construct comprises a central panel, at least one handle panel foldably connected to the central panel, and at least one locking flap foldably connected to the central panel. A portion of the at least one handle panel positioned between the at least one locking flap and the central panel such that the at least one handle panel is moveable relative to the central panel from a first position to a second position upon activation of the handle.

According to another aspect, the disclosure is generally directed to a combination of blanks for forming a carton for containing a plurality of articles, the combination of blanks comprising a carton blank comprising a plurality of panels for extending at least partially around an interior of the carton, the plurality of panels comprising a top panel, a bottom panel, a front panel, and a back panel, a plurality of end flaps foldably connected to a respective panel of the plurality of panels and for being in at least partially overlapping relation to form at least one closed end of the carton, and a reinforcement blank for forming a reinforcement construct for being positioned overlapping a portion of the carton formed from the carton blank and having handle features for at least partially forming a handle of the carton. The reinforcement blank comprises a central panel, at least one handle panel foldably connected to the central panel, and at least one locking flap foldably connected to the central panel, a portion of the at least one handle panel for being positioned between the at least one locking flap and the central panel when the carton is formed from the carton blank and the reinforcement blank such that the at least one handle panel is moveable relative to the central panel from a first position to a second position upon activation of the handle of the carton.

According to another aspect, the disclosure is generally directed to a method of forming a carton for containing a plurality of articles, the method comprises obtaining a carton blank comprising a plurality of panels for extending at least partially around an interior of the carton, the plurality of panels comprising a top panel, a bottom panel, a front panel, and a back panel, a plurality of end flaps foldably connected to a respective panel of the plurality of panels and for being in at least partially overlapping relation to form at least one closed end of the carton. The method comprises obtaining a reinforcement blank having handle features, the reinforcement blank comprises a central panel, at least one handle panel foldably connected to the central panel, and at least one locking flap foldably connected to the central panel, and forming a handle from the handle features by positioning a portion of the at least one handle panel between the at least one locking flap and the central panel, such that the at least one handle panel is moveable relative to the central panel from a first position to a second position upon activation of the handle of the carton, and forming a reinforcement construct by positioning the reinforcement blank to overlap a portion of the carton blank.

Those skilled in the art will appreciate the above stated advantages and other advantages and benefits of various additional embodiments reading the following detailed description of the embodiments with reference to the below-listed drawing figures.

### BRIEF DESCRIPTION OF THE DRAWINGS

According to common practice, the various features of the drawings discussed below are not necessarily drawn to scale. Dimensions of various features and elements in the drawings may be expanded or reduced to more clearly illustrate the embodiments of the disclosure.

FIG. 1 is a plan view of an exterior surface of a carton blank for forming a carton according to an exemplary embodiment of the disclosure.

FIG. 1A is an enlarged view of a portion of the blank of FIG. 1.

FIG. 2 is a plan view of an exterior surface of a reinforcement blank for forming a reinforcement construct according to the first exemplary embodiment of the disclosure.

FIG. 3 is a perspective view of a container suitable for use with reinforced cartons according to exemplary embodiments of the present disclosure.

FIGS. 4-8 are views of the formation of a reinforcement construct from the reinforcement blank of FIG. 2 according to exemplary embodiments of the present disclosure.

FIG. 9 is a perspective view of a carton formed from the blank of FIG. 1 according to exemplary embodiments of the present disclosure.

FIG. 10 is a perspective view of a portion of the reinforced carton with a handle thereof being activated.

FIG. 11 is a perspective view of the reinforcement construct of the reinforced carton of FIG. 10 shown in isolation with handle features thereof being activated according to exemplary embodiments of the present disclosure.

FIG. 12A is a schematic view of the handle of the reinforced carton in the position of FIG. 9.

FIG. 12B is a schematic view of the handle of the reinforced carton in the activated position of FIGS. 10 and 11.

Corresponding parts are designated by corresponding reference numbers throughout the drawings.

### DETAILED DESCRIPTION

The present disclosure generally relates to cartons that contain articles, for example, containers such as bottles, cans, etc. The articles can be used, for example, for packaging food and beverage products. The articles can be made from materials suitable in composition for packaging the particular food or beverage item, and the materials include, but are not limited to, aluminum and/or other metals; glass; plastics such as PET, LDPE, LLDPE, HDPE, PP, PS, PVC, EVOH, and Nylon; and the like, or any combination thereof.

Cartons according to the present disclosure can accommodate articles of any shape. For the purpose of illustration and not for the purpose of limiting the scope of the disclosure, the following detailed description describes beverage containers (e.g., aluminum cans or glass beverage bottles) as disposed within the carton embodiments. In this specification, the terms “inner,” “outer,” “lower,” “bottom,” “upper,” and “top” indicate orientations determined in relation to fully erected and upright cartons.

As described herein, cartons may be formed by multiple overlapping panels and/or end flaps. Such panels and/or end flaps may be designated in relative terms to one another, e.g., “first”, “second”, “third”, etc., in sequential or non-sequential reference, without departing from the disclosure.

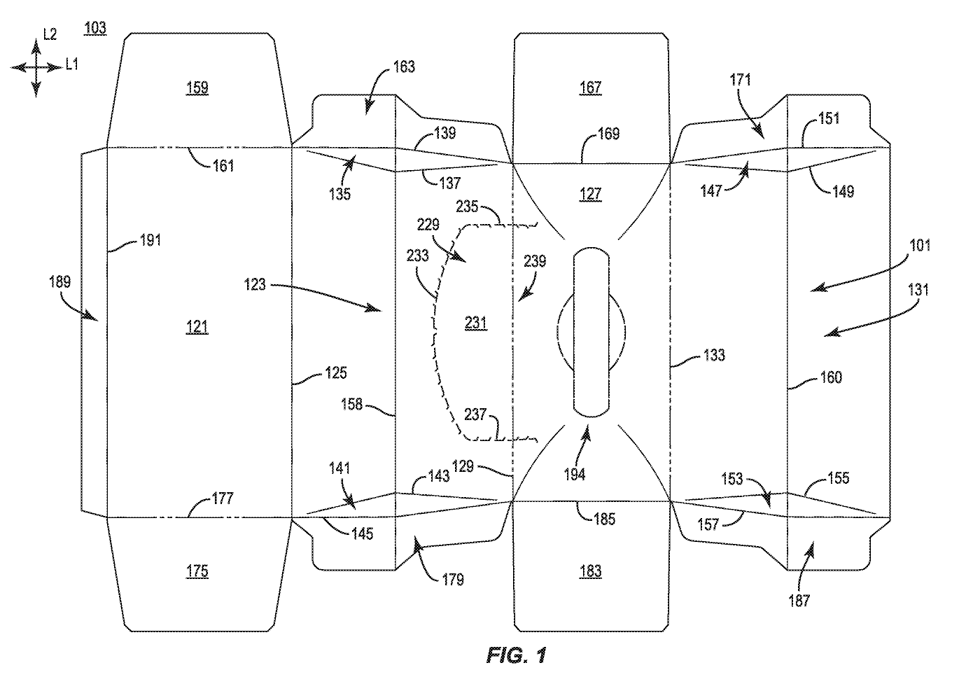

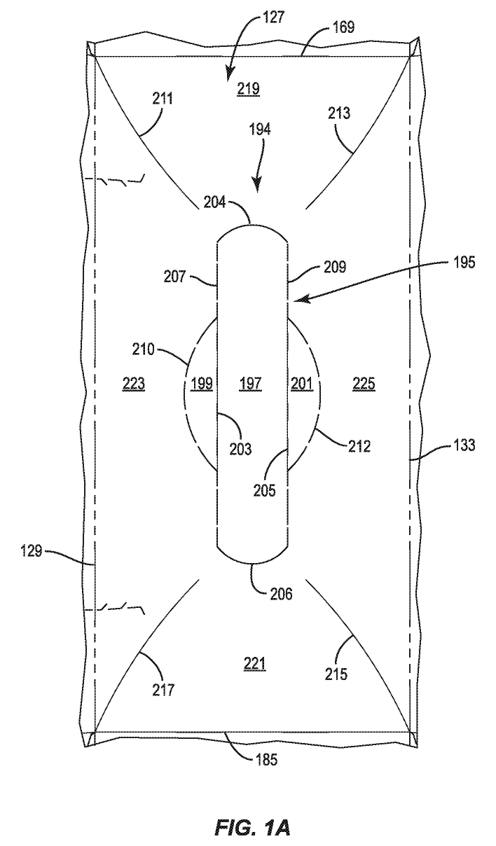

FIG. 1 shows a plan view of the exterior surface 101 (Add to FIG. 1) of a first blank or carton blank, generally indicated at 103, that can be obtained to form a carton 105 (FIG. 19) according to an exemplary embodiment of the disclosure. FIG. 1A is an enlarged view of a portion of the blank 103.

As described herein, the carton 105 can be used to house a plurality of articles in an interior 107 (FIG. 10) thereof such as containers in the form of beverage containers C (FIG. 3) the containers can be beverage bottles, e.g., bottles formed of glass or metal, and having upper portions that include an at least partially tapered neck portion intersecting a flange that at least partially supports a cap. In other embodiments, the containers could be beverage cans or another suitable type and size of container.

The carrier 105 could be sized to contain or support eight containers C in four rows of five containers, but it will be understood that the carrier 105 can be sized and shaped to hold containers of a different or same quantity in more than one layer and/or in different row/column arrangements (e.g., 1x6, 2x2, 2x3, 2x4, 2x5, 2x6, 3x3, 3x4, 2x5, 3x6, 2x6x2, 3x5, 3x4, 4x5, 2x9, 2x6, 4x4, 4x5, 4x6, etc.), as described further herein.

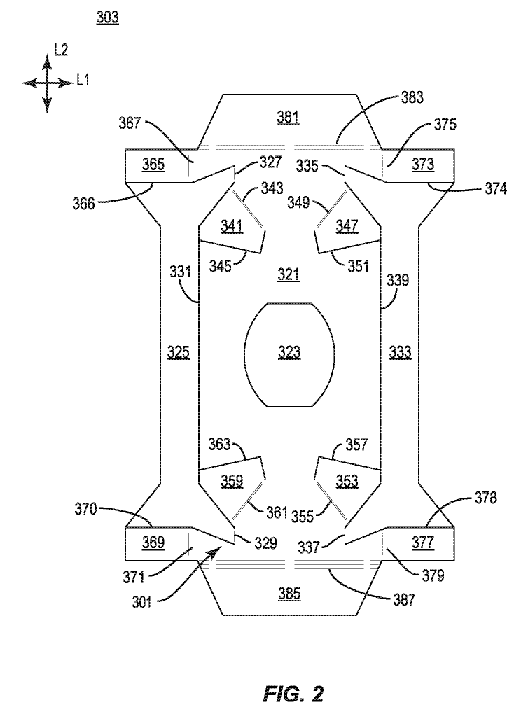

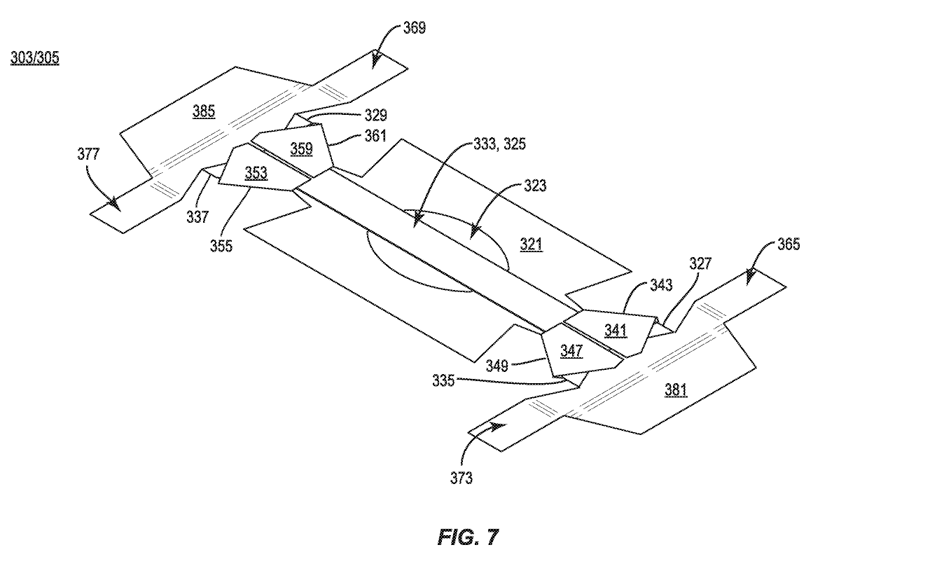

As also described herein, the carton 105 can be provided together with a reinforcement construct 305 (FIG. 7) formed from a reinforcement blank 303 (FIG. 2) to form a system or reinforced carton 110 (FIG. 10). The reinforced carton 110 can be provided with one or more containers C as a package.

With continued reference to FIG. 1, the blank 103 can have a longitudinal axis L1 and a lateral axis L2, and a plurality of panels for at least partially extending around an interior 107 of the carton 105 formed from the blank 103. As described herein, the interior 107 of the carton 105 formed from the blank 103 can also be the interior 107 of the reinforced carton 110.

In one embodiment, the plurality of panels can include a bottom panel 121, a front panel 123 foldably connected to the bottom panel 121 at a lateral fold line 125, a top panel 127 foldably connected to the back panel 123 at a lateral fold line 129, and a back panel 131 foldably connected to the top panel 127 at a lateral fold line 133. In some embodiments, one or both of the fold lines 129, 133 can be a line of weakening that includes one or more tear portions therealong collinear with one or more fold line portions therealong.

As shown in FIG. 1, a first front corner panel 135 can be foldably connected to the front panel 123 at a fold line 137 formed of a pair of intersecting oblique segments, the front corner panel 135 at least partially defined between the fold line 137 and a fold line 139 formed of a pair of intersecting oblique segments. It will be understood that the corner panel 135 and/or one or both of the associated fold lines 137, 139 can have a different configuration without departing from the disclosure. A second front corner panel 141 can be foldably connected to the front panel 123 at a fold line 143 such that the front corner panel 141 can be at least partially defined between the fold line 143 and a fold line 145. As shown, the fold lines 143, 145 can be formed of a respective pair of intersecting oblique segments, though the front corner panel 141 and/or one or both of the associated fold lines 143, 145 can have a different configuration without departing from the disclosure.

Similarly, a first back corner panel 147 can be foldably connected to the back panel 131 at a fold line 149 formed of a pair of intersecting oblique segments such that the corner panel 147 is at least partially defined between the fold line 149 and a fold line 151 formed of a pair of intersecting oblique segments. It will be understood that the corner panel 147 and/or one or both of the associated fold lines 149, 151 can have a different configuration without departing from the disclosure. In addition, a second back corner panel 153 can be foldably connected to the front panel 131 at a fold line 155 such that the corner panel 153 is at least partially defined between the fold line 155 and a fold line 157. Each fold lines 155, 157, as shown, can be formed of a respective pair of intersecting oblique segments, though it will be understood that the corner panel 153 and/or one or both of the associated fold lines 155, 157 can have a different configuration without departing from the disclosure.

In the illustrated embodiment, a plurality of end flaps can be foldably connected to a respective panel of the plurality of panels of the blank 103 and the carton 105 formed therefrom, and can include a first bottom end flap 159 foldably connected to the bottom panel 121 at a longitudinal fold line 161. A first front end flap 163 can be foldably connected to the corner panel 135 at the fold line 139, and can be foldably connected to the front panel 123 at portions of the fold line 139 that extends past respective endpoints of the fold line 137. A first top end flap 167 can be foldably connected to the top panel 127 at a longitudinal fold line 169. A first back end flap 171 can be foldably connected to the corner panel 147 at the fold line 151, and can be foldably connected to the back panel 131 at portions of the fold line 151 that extends beyond endpoints of the fold line 149.

Similarly, a second bottom end flap 175 can be foldably connected to the bottom panel 121 at a longitudinal fold line 177, a second front end flap 179 can be foldably connected to the corner panel 141 at the fold line 145 and can be foldably connected to the front panel 123 at portions of the fold line 145 that extend beyond endpoints of the fold line 143. A second top end flap 183 can be foldably connected to the top panel 127 at a longitudinal fold line 185, and a second back end flap 187 can be foldably connected to the corner panel 153 at the fold line 157 and can be foldably connected to the back panel 131 at portions of the fold line 157 that extend beyond endpoints of the fold line 155.

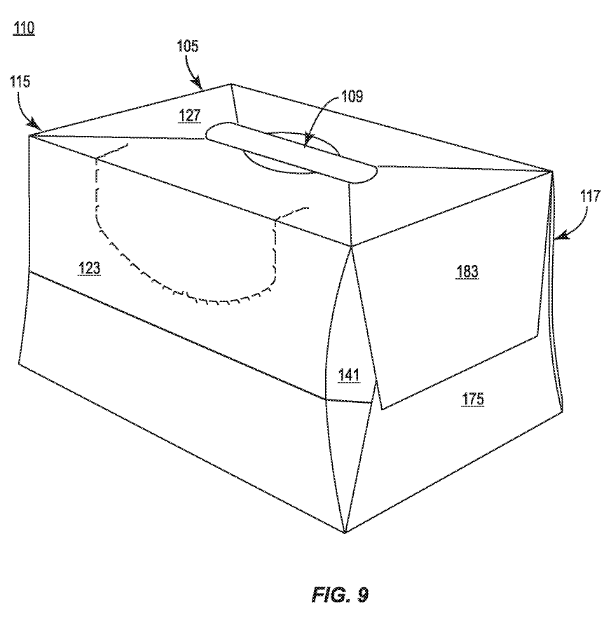

In this regard, the end flaps 159, 163, 167, 171 can extend along a marginal portion of the blank 103 for at least partially forming a first closed end 115 (FIG. 9) of the carton 105 formed from the blank 103, and the end flaps 175, 179, 183, 184 can extend along an opposite marginal portion of the blank 103 for at least partially forming a second closed end 117 (FIG. 9) of the carton 105 formed from the blank 103. It will be understood that the ends 115, 117 of the carton 105 can also be the ends 115, 117 of the reinforced carton 110, and the ends 115, 117 can be closed by other flaps, panels, etc. without departing from the disclosure.

An attachment flap 189 can be foldably connected to the bottom panel 121 at a lateral line of weakening 191. In some embodiments, the attachment flap 189 can be an end flap of the plurality of end flaps, but the attachment flap 189 can be considered a panel of the plurality of panels without departing from the disclosure.

As shown, a lateral fold line 158 can bisect the front panel 123, the corner panels 135, 141, and the end flaps 163, 179, and a lateral fold line 160 can bisect the back panel 131, the corner panels 147, 153, and the end flaps 171, 187. As described further herein, the fold lines 158, 160 can facilitate erection of the carton 105 from the blank 103.

The blank 103 and carton 105 formed therefrom can also include handle features 194 for forming at least a portion of a handle 109 of the reinforced carton 110. With additional reference to FIG. 1A, the handle features 194 can include a handle grip portion 195 at least partially defined in the top panel 127. A handle panel 197, as shown, can have a generally rounded rectangular configuration and can be foldably connected to respective handle reinforcement flaps 199, 201 at respective lateral fold lines 203, 205.

In one embodiment, the handle panel 197 can be separated from the top panel 127 at a respective pair of opposed lines of weakening 204, 206, and a pair of spaced apart laterally-extending lines of weakening 207, 209 interrupted by respective curved lines of weakening 210, 212 at which the handle reinforcement flaps 199, 201 are separably connected to the top panel 127.

With continued reference to FIGS. 1 and 1A, respective oblique lines of weakening 211, 213, 215, 217 extend from the handle grip portion 195 in the top panel 127 at generally 45 degree positions relative to the axes L1, L2 (from the perspective of FIG. 1A), though a different arrangement could be provided without departing from the disclosure. A first end relief portion 219 can be at least partially defined in the top panel 127 between the lines of weakening 211, 213 and a second end relief portion 221 can be at least partially defined in the top panel 127 between the lines of weakening 215, 217. Similarly, a first side relief portion 223 can be at least partially defined in the top panel 127 between the lines of weakening 211, 215 and a second side relief portion 225 can be at least partially defined in the top panel 127 between the lines of weakening 213, 215.

It will be understood that the handle features 194 of the blank 103 and carton 105 formed therefrom can have be otherwise shaped, arranged, configured, and/or omitted without departing from the disclosure.

In one embodiment, the blank 103 and carton 105 formed therefrom can include dispenser features for forming a dispenser of the carton 105/reinforced carton 110 and that can include a dispenser panel 229 having a front portion 231 at least partially defined by a portion of the fold line 129, a curved tear line 233, and portions of a pair of spaced apart lateral tear lines 235, 237 that extend from endpoints of the curved tear line 233 to the fold line 129. The tear lines 235, 237 can intersect the fold line 129 to extend at least partially into the top panel 127 to at least partially define a top portion 239 of the dispenser panel 229, the top portion 239 of the dispenser panel 229 foldably connected to the front portion 231 thereof at the respective portion of the fold line 129. The dispenser features of the blank 103 and carton 105 can be otherwise shaped, arranged, configured, and/or omitted without departing from the disclosure.

Turning to FIG. 2, the exterior surface 301 of the reinforcement blank 303 is illustrated. As described herein, the reinforcement blank 303 can be provided in combination with the carton blank 103 such that the reinforced carton 110 can be formed therefrom. In one embodiment, the reinforcement blank 303 can be attached to the carton blank 103 to form the reinforced carton 110.

As shown, the reinforcement blank 303 can have the longitudinal axis L1 and the lateral axis L2, and can include a reinforcement panel or central panel 321 at least partially defining a central opening 323 therein. A first handle panel or handle strap 325 is foldably connected to the central panel 321 at a pair of spaced apart lateral fold lines 327, 329, and the handle strap 325 can be separably connected to the central panel 321 at a cut 331 that extends from an endpoint of the fold line 327 to an endpoint of the fold line 329 and having one or more of straight, curved and/or angled portions.

Similarly, a second handle panel or handle strap 333 can be foldably connected to the central panel 321 at a pair of spaced apart lateral fold lines 335, 337, and the handle strap 333 can be separably connected to the central panel 321 at a cut 339 that extends from an endpoint of the fold line 335 to an endpoint of the fold line 337 and having one or more of straight, curved and/or angled portions.

As shown in FIG. 2, a first handle locking flap 341 can be foldably connected to the central panel 321 at an oblique fold line 343 and can be at least partially separably connected to the central panel 321 at a cut 345 having intersecting oblique segments. The handle locking flap 341 can be at least partially separably connected to the handle strap 325 at a respective portion of the cut 331.

Similarly, a second handle locking flap 347 can be foldably connected to the central panel 321 at an oblique fold line 349 and can be at least partially separably connected thereto at a cut 351 with intersecting oblique segments. The handle locking flap 347 can be at least partially separably connected to the handle strap 333 at a respective portion of the cut 339.

In the illustrated embodiment, a third handle locking flap 353 can be foldably connected to the central panel 321 at an oblique fold line 355, and can be at least partially separably connected to the central panel 321 at a cut 357 having intersecting oblique segments. The handle locking flap 353 can be at least partially separably connected to the handle strap 333 at a respective portion of the cut 339.

In addition, a fourth handle locking flap 359 can be foldably connected to the central panel 321 at an oblique fold line 361, and can be at least partially separably connected to the central panel 321 at a cut 363 having intersecting oblique segments. The handle locking flap 359 can be at least partially separably connected to the handle strap 325 at a respective portion of the cut 331.

It will be understood that one or more of the handle locking flaps 341, 347, 353, 359 and/or associated features can have a different configuration without departing from the disclosure and that any of the handle features could be otherwise shaped, arranged, configured, and/or omitted without departing from the disclosure.

In one embodiment, a plurality of reinforcement flaps can be at least partially foldably connected to the central panel 321 at a respective first end and second end of the reinforcement blank 303. The reinforcement flaps can include a first side reinforcement flap 365 foldably connected to the central panel 321 at a plurality of fold lines 367, a second side reinforcement flap 373 foldably connected to the central panel 321 at a plurality of fold lines 375, and a central reinforcement flap 381 foldably connected to the central panel 321 at a plurality of fold lines 383. The side reinforcement flaps 365, 373 are at least partially separably connected to a respective handle strap 325, 333 at respective cuts 366, 374 that can extend at least partially into the central panel 321.

Similarly, the reinforcement blank 303 includes a first side reinforcement flap 369, a second side reinforcement flap 377, and a central reinforcement flap 385 at the second end of the reinforcement blank. The first side reinforcement flap 369 is foldably connected to the central panel 321 at a plurality of fold lines 371, the second side reinforcement flap 377 is foldably connected to the central panel 321 at a plurality of fold lines 379, and the central reinforcement flap 385 is foldably connected to the central panel 321 at a plurality of fold lines 387. The side reinforcement flaps 369, 377 are at least partially separably connected to a respective handle panels 325, 333 at respective cuts 370, 378 that can extend at least partially into the central panel 321. The reinforcement blank 303 can have other features and the features shown can be otherwise shaped, arranged, configured, and/or omitted without departing from the disclosure.

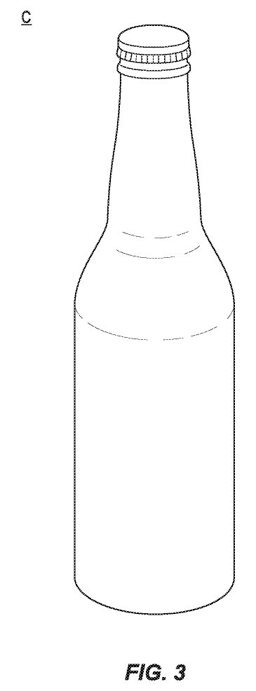

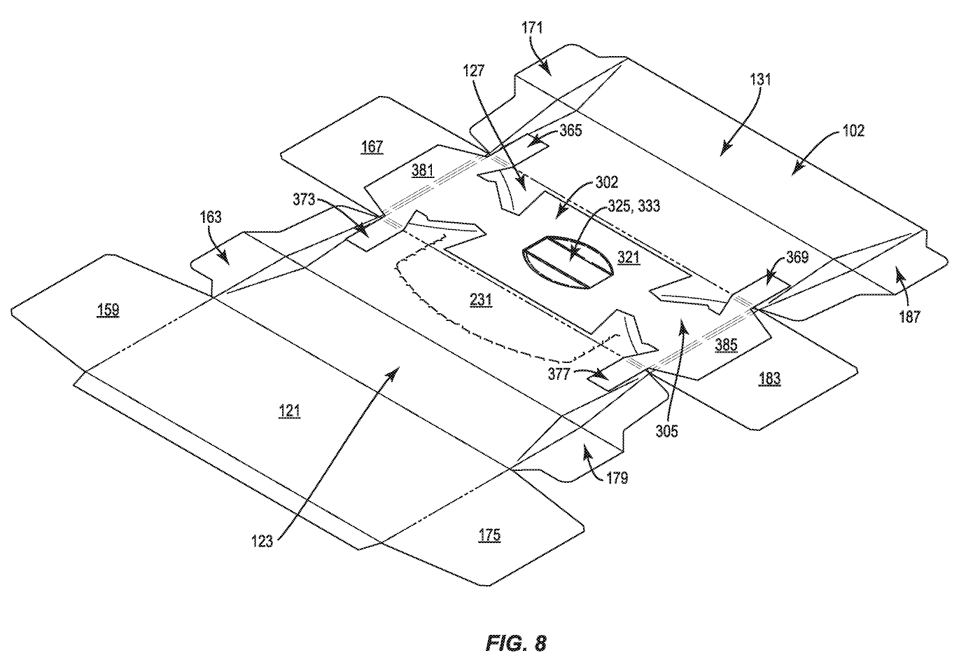

With additional reference to FIGS. 4-9, according to some embodiments, the construct blank 103 can be positioned with the exterior surface 101 thereof on a supporting surface and with an interior surface 102 (FIG. 8) thereof (e.g., a planar surface of the blank 103 opposite the exterior surface 101) facing upwardly. In such arrangement, the reinforcement blank 303 can be positioned with the exterior surface 301 thereof in at least partial face-to-face contact with the interior surface 102 of the carton blank 103, and with an interior surface 302 of the reinforcement blank 303 facing upwardly.

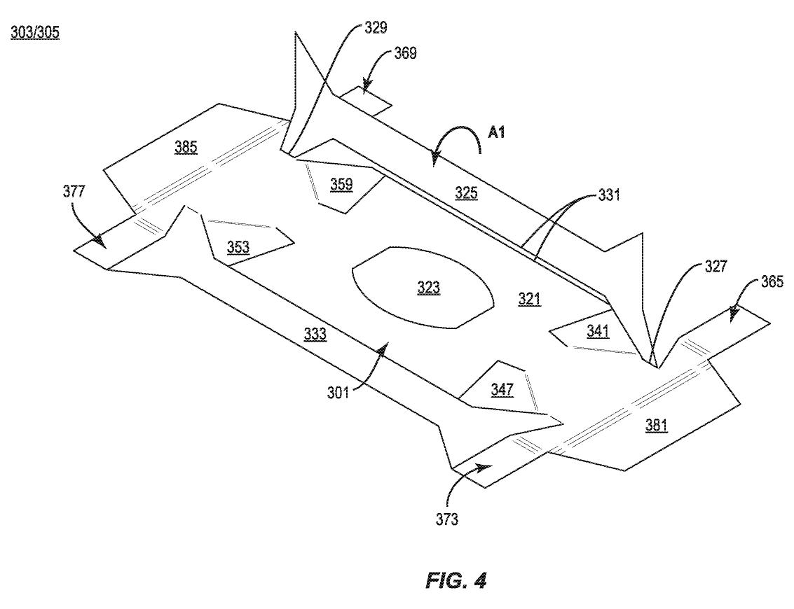

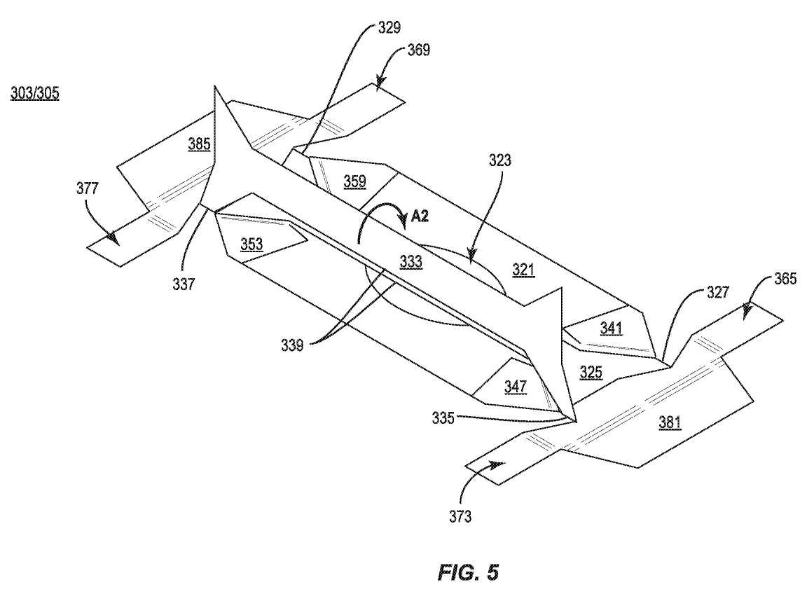

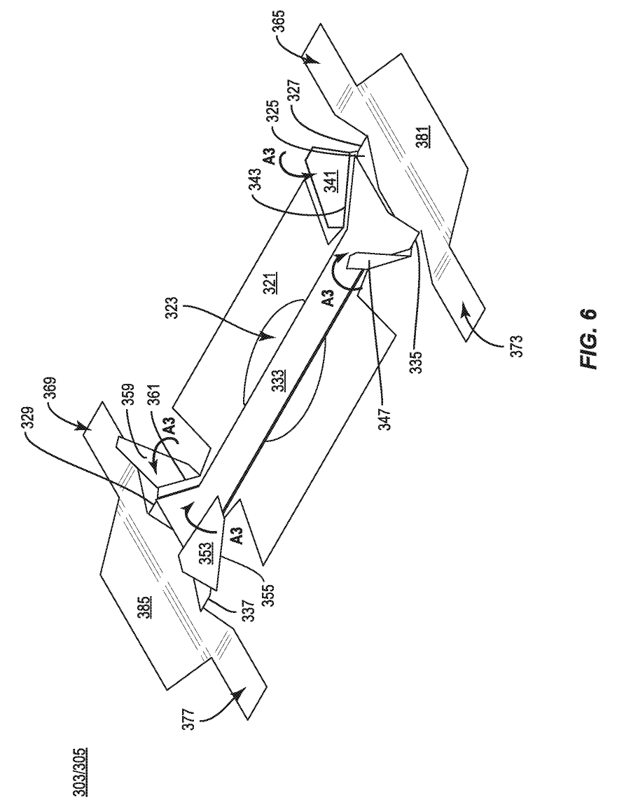

Prior to such positioning of the reinforcement blank 303 relative to the carton blank 103, the reinforcement blank 303 can be folded and/or positioned as generally shown in FIGS. 4-7. In one embodiment, the handle panel 325 can be at least partially separated from the central panel 321 at the cut 331 and from the side reinforcement flaps 365, 369 at respective cuts 366, 370 and can be folded at the fold lines 327, 329 in the direction of arrow A1 into at least partial face-to-face contact with the central panel 321 so as to be aligned with the central opening 323 (FIGS. 4-5). Further, the handle strap 333 can be at least partially separated from the central panel 321 at the cut 339 and from the side reinforcement flap end flaps 373, 377 at respective cuts 374, 378 and can be folded at the fold lines 335, 337 in the direction of arrow A2 into at least partial face-to-face contact with and aligned with the handle strap 325 (FIGS. 5-6). In one embodiment, the handle strap 333 overlies and is in face-to-face contact with the handle strap 325. Alternatively, the handle strap 333 could be first folded into face-to-face contact with the central panel 321 and the handle strap 325 folded to overlay and be in face-to-face contact with the handle strap 333 without departing from the disclosure.

As shown in FIGS. 6-7, the locking flaps 341, 347, 353, 359 can be folded into contact with the overlapped handle panels 325, 333. In the illustrated embodiment, the locking flap 341 can be at least partially separated from the central panel 321 at the cut 345 and folded at the fold line 343 in the direction of arrow A3 (FIG. 6) into at least partial face-to-face contact with a respective portion of the handle panel 333 (or alternatively handle panel 325 depending upon which is overlapped upon the other). Similarly, the locking flap 347 can be at least partially separated from the central panel 321 at the cut 351 and folded at the fold line 349 in the direction of arrow A3 (FIG. 6) into at least partial face-to-face contact with a respective portion of the handle strap 333/325.

Similarly, the locking flap 353 can be at least partially separated from the central panel 321 at the cut 357 and folded at the fold line 355 in the direction of arrow A3 (FIG. 6) into at least partial face-to-face contact with a respective portion of the handle panel 333/325 and the locking flap 359 can be at least partially separated from the central panel 321 at the cut 363 and folded at the fold line 361 in the direction of arrow A3 (FIG. 6) into at least partial face-to-face contact with a respective portion of the handle strap 333/325. The locking flaps 341, 347 engage the overlapped handle straps 325, 333 at a respective first end of the reinforcement construct 305 and locking flaps 353, 359 engage the overlapped handle straps 325, 333 at respective second end of the reinforcement construct.

As shown in FIG. 8, the reinforcement blank 303/construct 305 can then be positioned such that the overlapped handle straps 325/333 are positioned between the top panel 127 of the carton blank 103 and the central panel 321 of the reinforcement blank 303. In this regard, the locking flaps 341, 347, 353, 359 of the reinforcement blank 303/construct 305 can be positioned in at least partial face-to-face contact with the top panel 127 to at least partially maintain the position of the handle straps 321, 333 extending thereunder. In one embodiment, the overlapped handle straps 321, 333 are positioned relative to the top panel 127 so that the handle strap 197 of the carton blank 103 is positioned to be in at least partial face-to-face contact with one of the overlapped handle straps 321, 333.

Such positioning of the reinforcement blank 303/construct 305 can also position the side reinforcement flaps 365, 369 in at least partial face-to-face contact with respective portions of the front panel 123 and the side reinforcement flaps 373, 377 in at least partial face-to-face contact with respective portions of the back panel 131. Further, the central reinforcement flap 381 of the reinforcement blank 303/construct 305 is in at least partial face-to-face contact with the end flap 167 of the carton blank 103, and the central reinforcement flap 385 is in at least partial face-to-face contact with the end flap 183 of the carton blank 103. It will be understood that the reinforcement blank 303/construct 305 can be differently oriented relative to the carton blank 103 without departing from the disclosure.

In one embodiment, the various panels of the carton blank 103, with the reinforcement construct attached, can be further positioned to form the reinforced carton 110. In such an arrangement, the front panel 123 can be folded at the fold line 158 such a portion of the front panel 123 is folded into at least partial face-to-face contact with a portion of itself, such that the bottom panel 121 is carried into at least partial face-to-face contact with a respective portion of the central panel 321 of the reinforcement blank 303, and such that the attachment flap 189 is carried into at least partial face-to-face contact with a portion of the front panel 131. Thereafter, a portion of the back panel 131 can be folded at the fold line 160 into at least partial face-to-face contact with another portion of the back panel 131 and the attachment flap 189. Such an arrangement can be considered a partially folded arrangement of the blank 103 and/or a collapsed configuration of the carton 105/reinforced carton 110. Thereafter, the top panel 127 and bottom panel 121 can be positioned in generally spaced and parallel relation, with the front panel 123 and the back panel 131 extending from the top panel 127 to the bottom panel 121 in generally spaced and parallel relation. The attachment flap 189 can be positioned in at least partial face-to-face contact with the back panel 131. Such an arrangement can be accomplished by folding the plurality of panels of the blank 103/carton 105 at one or more of the fold lines 125, 129, 133, 158, 160, 191.

Such an arrangement can be considered an open sleeve configuration of the carton 105/reinforced carton 110, in which the interior 107 of the carton 105/reinforced carton 110 is accessible, for example, for receiving one or more containers C therein. In some embodiments, one or more containers C can be positioned in the interior 107 of the carton 105/reinforced carton 110 through one or both open ends of the carton 105/reinforced carton 110, for example, via one or more actuated loading arms/pushers and/or conveyor mechanisms.

With additional reference to FIGS. 9 and 10, the corner panels 135, 147 can be folded at the respective fold lines 137, 149, the end flaps 163, 171 can be folded at the respective fold lines 139, 151, the end flap 159 can be folded upwardly at the fold line 161, and the end flap 167 can be folded downwardly at the fold line 169 into at least partial face-to-face contact with respective portions of the end flaps 159, 163, 171 to form the first closed end 115 of the carton 105/reinforced carton 110. Similarly, the corner panels 141, 153 can be folded at the respective fold lines 143, 155, the end flaps 179, 187 can be folded at the respective fold lines 145, 157, the end flap 175 can be folded upwardly at the fold line 177, and the end flap 183 can be folded downwardly at the fold line 185 into at least partial face-to-face contact with respective portions of the end flaps 175, 179, 187 to form the second closed end 117 of the carton 105/reinforced carton 110.

In the aforementioned closed-ended arrangement of the carton 105/reinforced carton 110, the corner panel 135 extends obliquely between the front panel 123 and the first closed end 115, the corner panel 147 extends between the back panel 131 and the closed end 115, the corner panel 141 extends between the front panel 123 and the closed end 117, and the corner panel 153 extends between the back panel 131 and the closed end 117.

In the course of forming the above-identified arrangement of the carton 105/reinforced carton 110, folding of the front panel 123 of the blank 103/carton 105 at the fold line 129 can cause the side reinforcement flaps 365, 369 of the blank 303/construct 305 to fold downwardly at the respective pluralities of fold lines 367, 371. The folding of the back panel 131 of the blank 103/carton 105 at the fold line 133 can cause the side reinforcement flaps 373, 377 of the blank 303/construct 305 to fold downwardly at the respective pluralities of fold lines 375, 379. The folding of the end flap 167 of the blank 103/carton 105 at the fold line 169 can cause the central reinforcement panel 381 to fold at least partially downwardly at the plurality of fold lines 383, and the folding of the end flap 183 of the blank 103/carton 105 at the fold line 185 can cause the central reinforcement flap 385 to fold at least partially downwardly at the plurality of fold lines 387 to form the construct 305 from the blank 303.

It will be understood that the above-described arrangement of the carton 105 and construct 305, including associated panels, end flaps, features, etc., can be at least partially maintained with one or more applications of an adhesive such as glue. For example, at least a portion of the central panel 321 of the reinforcement construct 305 can be attached to at least a portion of the top panel 127. In some embodiments, portions of one or more of the reinforcement flaps 365, 369, 373, 377, 381, 385 can be attached to one or more panels or end flaps of the blank/carton 105 without departing from the disclosure. Further, the handle strap 197 of the carton blank 103 can be attached to the overlapped handle panels 325, 333 of the reinforcement blank 303 by adhesive such as glue.

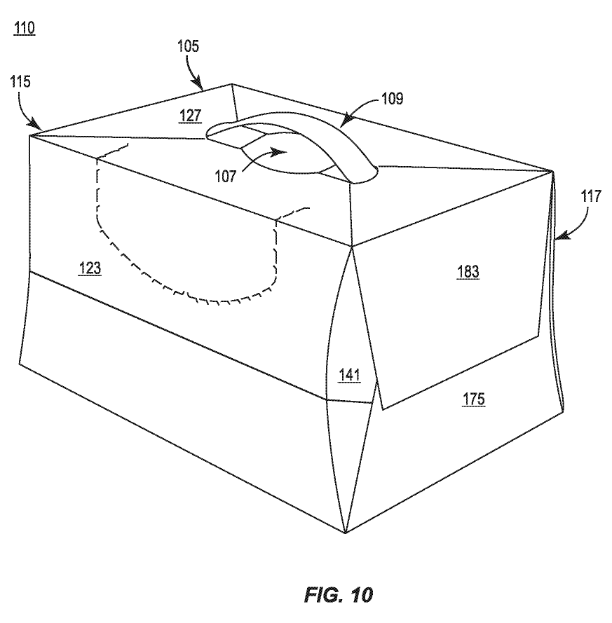

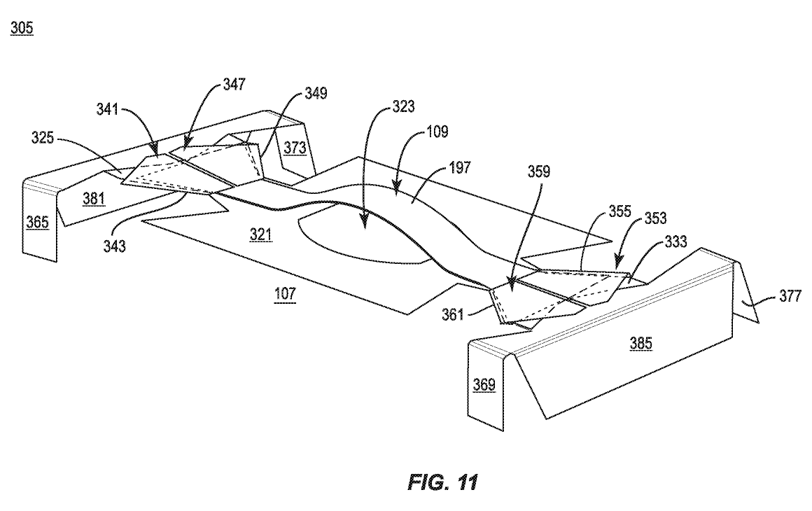

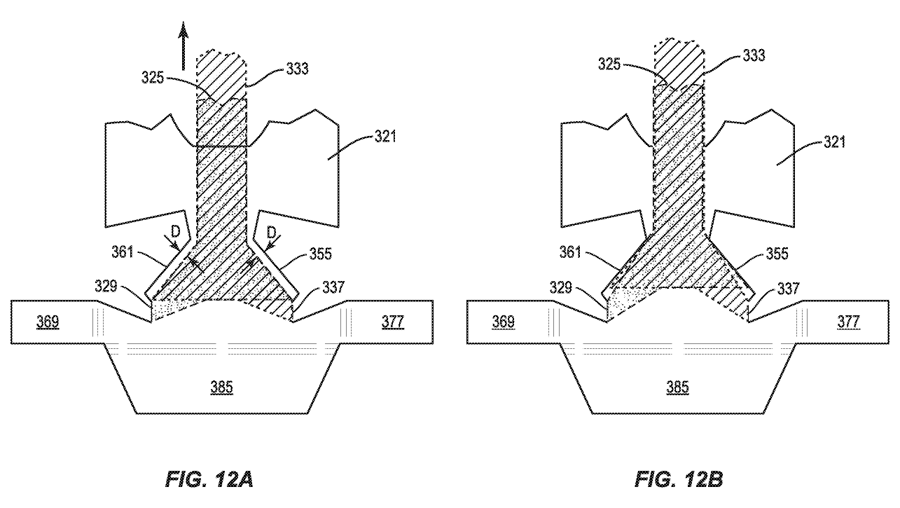

With additional reference to FIGS. 11-12B, in order to engage the handle 109 of the reinforced carton 110, for example, to lift, carry, or otherwise move the reinforced carton 110, a user can engage the handle reinforcement flaps 199, 201 and at least partially separate the handle reinforcement flaps 199, 201 from the top panel 127 of the carton 105 at the respective cuts 210, 212. The handle reinforcement flaps 199, 201 can be folded at least partially downwardly at the respective fold lines 203, 205 with respect to the handle panel 197 through the central opening 323 in the central panel 321 of the reinforcement construct 305 to access the interior 107 of the reinforced carton 110. In some embodiments, the handle reinforcement flaps 199, 201 can contact and/or at least partially curl around the handle panels 325, 333 positioned therebelow.

The user can thus grasp the handle 109 of the reinforced carton 110 that includes, from top to bottom, the handle panel 197, the handle strap 325, and the handle strap 333, such that a multi-ply, e.g., 3-ply, arrangement of panels is provided, e.g., for strength, for comfort, and/or to avoid unwanted tearing. The handle 109 can also include one or both of the handle reinforcement flaps 199, 201, which can provide an additional ply of material in with the handle panel 199 and handle straps 325, 333. Alternatively, the handle 109 could be constructed to be less than 3-ply (e.g., a single ply, or 2-ply) with the elimination of one or more of the handle panels 197, 325, 333 without departing from the disclosure.

In some embodiments, the user can grasp the handle 109 by at least partially curling his or her fingers through the central opening 323 in the central panel 321 of the reinforcement construct 305 around lateral edges of the handle 109. As the user lifts the handle 109, the handle panel 197 can at least partially separate from the top panel 127 at the lines of weakening 204, 206, 207, 209.

Further lifting and loading of the handle 109 with the weight of the containers C in the interior 107 of the reinforced carton 110 can cause the handle straps 325, 333 to at least partially move relative to adjacent portions of the reinforced carton 110. As shown in FIG. 12A, the fold lines 355, 361 connecting the respective locking flaps 353, 359 are spaced apart from an edge of the overlapped handle straps 325, 333 by a distance D before activation of the handle 109. Upon activation of the handle, the overlapped handle straps 325, 333 are pulled upwardly, end portions of the handle straps positioned between the central panel 321 of the reinforcement construct 305 and the respective locking flaps 341, 347, 353, 359 can move relative to the central panel 321 towards the respective fold lines 355, 361. Owing to the generally inverted tapered profile, e.g., widening or at least partially triangular in cross-section, of lateral end portions of the handle straps 325, 333, movement of the free edges of the handle straps 325, 333 against the locking flaps 341, 347, 353, 359, e.g., proximate the respective fold lines 343, 349, 355, 361, can cause stresses applied across the handle 109 to be dispersed/divided along points of contact with the locking flaps 341, 347, 359, 353 and portions of the central panel 321 adjacent the handle 109. In one embodiment, end portions of the overlapped handle straps 325, 333 are moved upon activation of the handle 109 to eliminate the distance D and engage the fold lines 355, 361 connecting the locking flaps 353, 359. Similar movement of the handle straps 325, 333 upon activation of the handle 109 occurs at the opposite ends of the handle straps so that edges of the handle straps engage the fold lines 349, 343 connecting the locking flaps 341, 347 in a similar manner. Alternatively the end portions of the handle straps 325, 333 could be moved less than the distance D upon activation of the handle without departing from the disclosure.

In some embodiments, the handle strap 325 can be positioned in at least partial face-to-face contact with the central panel 321 and can at least partially slide therealong (e.g., in sliding engagement with) as the handle 109 is pulled upwardly, and the handle strap 333 can be positioned in at least partial face-to-face contact with the locking flaps 341, 347, 353, 359 and can at least partially slide therealong (e.g., in sliding engagement with ) as the handle 109 is pulled upwardly.

In other embodiments, the handle strap 333 can be positioned in at least partial face-to-face contact with the central panel 321 and can at least partially slide therealong (e.g., in sliding engagement with) as the handle 109 is pulled upwardly, and the handle strap 325 can be positioned in at least partial face-to-face contact with the locking flaps 341, 347, 353, 359 and can at least partially slide therealong (e.g., in sliding engagement with) as the handle 109 is pulled upwardly.

Such relative movement of the handle 109 relative to adjacent portions of the reinforced carton 110 can provide a relatively even and widespread distribution of stresses due to the weight of the reinforced carton 110 and containers C held therein along portions of the reinforced carton 110, for example, to reduce pressure on the user’s hand(s), to inhibit tearing of one or more portions of the reinforced carton 110, etc.

In some embodiments, the aforementioned movement of the handle 109 can cause the handle grip portion 195 of the top panel 121 to at least partially move, e.g., raise or tilt, relative to the relief portions 219, 221, 223, 225 of the top panel 121 via at least partial movement thereof at the respective lines of weakening 211, 213, 215, 217. Such relative movement of portions of the top panel 121 of the reinforced carton 110 can further provide for the relief of stresses associated with lifting containers C held in the reinforced carton 110.

When it is desired to access one or more containers C in the interior 107 of the reinforced carton 110, a user can engage, e.g., press or lift, on the dispenser panel 229 and at least partially separate the front portion 231 of the dispenser panel 229 from the front panel 123 at the respective tear line 233 and respective portions of the tear lines 235, 237. Further separation of the dispenser panel 229 at respective portions of the tear lines 235, 237 can cause the top portion 239 thereof to at least partially separate from the top panel 127. The top portion 239 of the dispenser panel 229 can be articulable relative to the front portion 231 thereof at the respective portion of the fold line 129 to facilitate access to the interior 107 of the reinforced carton 110.

It will be understood that one or more portions of the blanks 103, 303, the carton 105 and construct 305 formed therefrom, respectively, and the reinforced carton 110 formed therefrom, can have a different configuration without departing from the disclosure.

For example, the handle 109 of the reinforced carton 110 described above can be adapted for use with various other carton configurations sized to hold a different number of containers C, a different size and shape of containers, or containers in more than one layer in the interior of the carton.

Any of the features of the various embodiments of the disclosure can be combined with, replaced by, or otherwise configured with other features of other embodiments of the disclosure without departing from the scope of this disclosure. Further, it is noted that the nesting arrangements and/or the features of the blanks and cartons of the various embodiments can be incorporated into a carton or blank having any carton style or panel configuration. The carton styles and panel configurations described above are included by way of example.

The blanks according to any of the embodiments of the present disclosure can be, for example, formed from coated paperboard and similar materials. For example, the interior and/or exterior sides of the blank can be coated with a clay coating. The clay coating may then be printed over with product, advertising, price coding, and other information or images. The blank may then be coated with a varnish to protect any information printed on the blank. The blank may also be coated with, for example, a moisture barrier layer, on either or both sides of the blank. In accordance with the above-described embodiments, the blank may be constructed of paperboard of a caliper such that it is heavier and more rigid than ordinary paper. The blank can also be constructed of other materials, such as cardboard, hard paper, or any other material having properties suitable for enabling the carton to function at least generally as described herein. The blank can also be laminated or coated with one or more sheet-like materials at selected panels or panel sections.

In accordance with the above-described embodiments of the present disclosure, a fold line can be any substantially linear, although not necessarily straight, form of weakening that facilitates folding therealong. More specifically, but not for the purpose of narrowing the scope of the present disclosure, fold lines include: a score line, such as lines formed with a blunt scoring knife, or the like, which creates a crushed portion in the material along the desired line of weakness; a cut that extends partially into a material along the desired line of weakness, and/or a series of cuts that extend partially into and/or completely through the material along the desired line of weakness; and various combinations of these features.

As an example, a tear line can include: a slit that extends partially into the material along the desired line of weakness, and/or a series of spaced apart slits that extend partially into and/or completely through the material along the desired line of weakness, or various combinations of these features. As a more specific example, one type of tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut line. That is, it is within the scope of the present disclosure for each of the tear lines to be replaced with a continuous slit, or the like. For example, a cut line can be a continuous slit or could be wider than a slit without departing from the present disclosure.

The above embodiments may be described as having one or more panels adhered together by glue during erection of the carton embodiments. The term “glue” is intended to encompass all manner of adhesives commonly used to secure carton panels in place.

The foregoing description of the disclosure illustrates and describes various exemplary embodiments. Various additions, modifications, changes, etc., could be made to the exemplary embodiments without departing from the spirit and scope of the disclosure. It is intended that all matter contained in the above description or shown in the accompanying drawings shall be interpreted as illustrative and not in a limiting sense. Additionally, the disclosure shows and describes only selected embodiments of the disclosure, but the disclosure is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

Additionally, spatially relative terms, such as "bottom or "top"; or “front” or “back”; and the like can be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a "bottom" surface can then be oriented "above" other elements or features. The device can be otherwise oriented (e.g., rotated 90 degrees or at other orientations) and the spatially relative descriptors used herein interpreted accordingly.

Terms “and,” “or,” and “an/or,” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, B, C, AB, AC, BC, AA, AAB, ABC, AABBCCC, etc.

Reference throughout this specification to “one example,” “an example,” “certain examples,” “exemplary embodiments”, or “exemplary implementation” means that a particular feature, structure, or characteristic described in connection with the feature and/or example may be included in at least one feature and/or example of claimed subject matter. Thus, the appearances of the phrase “in one example,” “an example,” “in certain examples,” “in certain implementations,” “in some embodiments”, or other like phrases in various places throughout this specification are not necessarily all referring to the same feature, example, and/or limitation. Furthermore, the particular features, structures, or characteristics may be combined in one or more examples and/or features.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter. Therefore, it is intended that claimed subject matter not be limited to the particular examples disclosed, but that such claimed subject matter may also include all aspects falling within the scope of appended claims, and equivalents thereof.

What is claimed is:

1. A carton for containing a plurality of articles, the carton comprising:
a plurality of panels extending at least partially around an interior of the carton, the plurality of panels comprising a top panel, a bottom panel, a front panel, and a back panel, a plurality of end flaps foldably connected to a respective panel of the plurality of panels and in at least partially overlapping relation to form at least one closed end of the carton,
handle features at least partially forming a handle of the carton, the handle features comprise a reinforcement construct overlapping a portion of the carton, the reinforcement construct comprises a central panel, at least one handle panel foldably connected to the central panel, and at least one locking flap foldably connected to the central panel, a portion of the at least one handle panel positioned between the at least one locking flap and the central panel such that the at least one handle panel is moveable relative to the central panel from a first position to a second position upon activation of the handle.

2. The carton of claim 1, wherein the at least one locking flap is a first locking flap, the reinforcement construct comprises a second locking flap.

3. The carton of claim 2, wherein the first locking flap and the second locking flap are in at least partial face-to-face contact with the portion of the at least one handle panel.

4. The carton of claim 2, wherein the at least one locking flap is foldably connected to the central panel at a fold line, the portion of the at least one handle panel includes an edge spaced apart from the fold line by a distance at the first position.

5. The carton of claim 4, wherein the at least one handle panel is moveable to the second position wherein the edge of the portion of the at least one handle panel contacts the fold line.

6. The carton of claim 1, wherein the at least one handle panel is a first handle panel, the reinforcement construct comprises a second handle panel in face-to-face contact with the first handle panel.

7. The carton of claim 6, wherein the reinforcement construct overlaps at least a portion of the top panel.

8. The carton of claim 7, wherein the handle features comprises a third handle panel in the top panel, the third handle panel being operatively connected to the first handle panel and the second handle panel.

9. The carton of claim 8, wherein the third handle panel is in face-to-face contact with one of the first handle panel and the second handle panel to form a 3-ply portion of the handle.

10. The carton of claim 1, wherein the reinforcement construct includes at least one reinforcement flap foldably connected to the central panel.

11. The carton of claim 10, wherein the at least one reinforcement flap comprise a first side reinforcement flap, a second side reinforcement flap, and a central reinforcement flap at a first end of the central panel.

12. The carton of claim 11, wherein the first side reinforcement flap and the second side reinforcement flap are in face-to-face contact with a respective panel of the plurality of panels, the central reinforcement flap is in face-to-face contact with a respective end flap of the plurality of end flaps.

13. The carton of claim 12, wherein:
the closed end is a first closed end;
the plurality of end flaps is a first plurality of first end flaps that are overlapped with respect to one another to form the first closed end; and
the carton comprises a second plurality of second end flaps respectively foldably attached to respective panels of the plurality of panels, wherein the second end flaps are overlapped with respect to one another to form a second closed end of the carton,
the first side reinforcement flap, second side reinforcement flap, and the central reinforcement flaps are at the first closed,
the reinforcement construct comprises at least one reinforcement flap at a second end of the central panel and at the second closed end of the carton.

14. A combination of blanks for forming a carton for containing a plurality of articles, the combination of blanks comprising a carton blank comprising a plurality of panels for extending at least partially around an interior of the carton, the plurality of panels comprising a top panel, a bottom panel, a front panel, and a back panel, a plurality of end flaps foldably connected to a respective panel of the plurality of panels and for being in at least partially overlapping relation to form at least one closed end of the carton, and
a reinforcement blank for forming a reinforcement construct for being positioned overlapping a portion of the carton formed from the carton blank and having handle features for at least partially forming a handle of the carton, the reinforcement blank comprises a central panel, at least one handle panel foldably connected to the central panel, and at least one locking flap foldably connected to the central panel, a portion of the at least one handle panel for being positioned between the at least one locking flap and the central panel when the carton is formed from the carton blank and the reinforcement blank such that the at least one handle panel is moveable relative to the central panel from a first position to a second position upon activation of the handle of the carton.

15. The combination of blanks of claim 14, wherein the at least one locking flap is a first locking flap, the reinforcement blank comprises a second locking flap.

16. The combination of blanks of claim 15, wherein the first locking flap and the second locking flap are in at least partial face-to-face contact with the portion of the at least one handle panel when the carton is formed form the carton blank and the reinforcement blank.

17. The combination of blanks of claim 15, wherein the at least one locking flap is foldably connected to the central panel at a fold line, the portion of the at least one handle panel includes an edge spaced apart from the fold line by a distance at the first position.

18. The combination of blanks of claim 17, wherein the at least one handle panel is moveable to the second position wherein the edge of the portion of the at least one handle panel contacts the fold line.

19. The combination of blanks of claim 14, wherein the at least one handle panel is a first handle panel, the reinforcement blank comprises a second handle panel in face-to-face contact with the first handle panel.

20. The combination of blanks of claim 19, wherein the reinforcement construct overlaps at least a portion of the top panel, the carton blank comprises a third handle panel in the top panel, the third handle panel being operatively connected to the first handle panel and the second handle panel.

21. The combination of blanks of claim 14, wherein the reinforcement construct includes at least one reinforcement flap foldably connected to the central panel, the at least one reinforcement flap comprise a first side reinforcement flap, a second side reinforcement flap, and a central reinforcement flap at an end of the central panel.

22. The combination of blanks of claim 21, wherein the first side reinforcement flap and the second side reinforcement flap are in face-to-face contact with a respective panel of the plurality of panels, the central reinforcement flap is in face-to-face contact with a respective end flap of the plurality of end flaps.

23. A method of forming a carton for containing a plurality of articles, the method comprises:
obtaining a carton blank comprising a plurality of panels for extending at least partially around an interior of the carton, the plurality of panels comprising a top panel, a bottom panel, a front panel, and a back panel, a plurality of end flaps foldably connected to a respective panel of the plurality of panels and for being in at least partially overlapping relation to form at least one closed end of the carton; and
obtaining a reinforcement blank having handle features, the reinforcement blank comprises a central panel, at least one handle panel foldably connected to the central panel, and at least one locking flap foldably connected to the central panel;
forming a handle from the handle features by positioning a portion of the at least one handle panel between the at least one locking flap and the central panel, such that the at least one handle panel is moveable relative to the central panel from a first position to a second position upon activation of the handle of the carton; and
forming a reinforcement construct by positioning the reinforcement blank to overlap a portion of the carton blank.

24. The method of claim 23, wherein the at least one locking flap is a first locking flap, the reinforcement construct comprises a second locking flap, the forming the handle comprises positioning the first locking flap and the second locking flap in at least partial face-to-face contact with the portion of the at least one handle panel.

25. The method of claim 24, wherein the at least one locking flap is foldably connected to the central panel at a fold line, the portion of the at least one handle panel includes an edge spaced apart from the fold line by a distance at the first position.

26. The method of claim 25, wherein the at least one handle panel is moveable to the second position wherein the edge of the portion of the at least one handle panel contacts the fold line.

27. The method of claim 23, wherein the at least one handle panel is a first handle panel, the reinforcement construct comprises a second handle panel, the forming the handle comprises positioning the second handle panel in face-to-face contact with the first handle panel.

28. The method of claim 27, wherein the reinforcement construct overlaps at least a portion of the top panel.

29. The method of claim 28, wherein the carton blank comprises a third handle panel in the top panel, the third handle panel being operatively connected to the first handle panel and the second handle panel.

30. The method of claim 29, wherein the forming the handle comprises positioning the third handle panel in face-to-face contact with one of the first handle panel and the second handle panel to form a 3-ply portion of the handle.

31. The method of claim 23, wherein the reinforcement construct includes at least one reinforcement flap foldably connected to the central panel, the at least one reinforcement flap comprise a first side reinforcement flap, a second side reinforcement flap, and a central reinforcement flap at a first end of the central panel.

32. The method carton of claim 31, wherein the first side reinforcement flap and the second side reinforcement flap are in face-to-face contact with a respective panel of the plurality of panels, the central reinforcement flap is in face-to-face contact with a respective end flap of the plurality of end flaps.

33. The carton of claim 32, wherein:
the closed end is a first closed end;
the plurality of end flaps is a first plurality of first end flaps that are overlapped with respect to one another to form the first closed end; and
the carton comprises a second plurality of second end flaps respectively foldably attached to respective panels of the plurality of panels, wherein the second end flaps are overlapped with respect to one another to form a second closed end of the carton,
the first side reinforcement flap, second side reinforcement flap, and the central reinforcement flaps are at the first closed,
the reinforcement construct comprises at least one reinforcement flap at a second end of the central panel and at the second closed end of the carton.
